(19) United States
(12) Patent Application Publication
(10) Pub. No.: US 2024/0246109 A1
(43) Pub. Date: Jul. 25, 2024

(54) NOZZLE TIP COVER FOR URETHANE ROBOTS

(71) Applicant: TOYOTA MOTOR ENGINEERING & MANUFACTURING NORTH AMERICA, INC., Plano, TX (US)

(72) Inventors: EDWARD A. FOLEY, Stamping Ground, KY (US); Matthew T. Downs, Georgetown, KY (US); Ryan T. Creech, Georgetown, KY (US)

(73) Assignees: TOYOTA MOTOR ENGINEERING & MANUFACTURING NORTH AMERICA, INC., Plano, TX (US); TOYOTA JIDOSHA KABUSHIKI KAISHA, TOYOTA-SHI, AICHI-KEN (JP)

(21) Appl. No.: 18/159,001

(22) Filed: Jan. 24, 2023

(51) Int. Cl. B05C 11/00

(52) U.S. Cl. CPC B05C 11/00

(57) ABSTRACT

Systems and methods herein provide for covering the tips of nozzles of urethane robots. A tip cover includes a first housing portion having a first inner wall curved to form a first cavity, the first housing portion having a first channel recessed into the first inner wall. A second housing portion has a second inner wall curved to form a second cavity, the second housing portion having a second channel recessed into the second inner wall. The first and second housing portions are configured to be mated together such that the first and second cavities together form a chamber to enclose or surround a nozzle tip, and the first and second channels together form an O-ring channel for receiving and sealing around an O-ring disposed around the nozzle tip.

### TECHNICAL FIELD

The present disclosure relates to a device and method for covering the tips of nozzles for sealant-dispensing robots such as urethane robots. More particularly, some implementations may relate to a nozzle tip cover for sealant-dispensing robots that enables improved automotive window sealing.

### DESCRIPTION OF RELATED ART

Automotive window sealing applications typically involve robots that apply or dispense sealants such as urethane. The robots dispense the urethane/sealant using a nozzle, the urethane/sealant exiting from a tip portion of the nozzle. There is a need for improved consistency in the dispensing of urethanes and other sealants from the nozzle tips.

### BRIEF SUMMARY OF THE DISCLOSURE

According to various embodiments of the disclosed technology, systems, devices, and methods are provided for covering the tips of nozzles of sealant-dispensing robots such as urethane robots. An improved nozzle tip cover can provide for more successful automotive window sealing.

In accordance with some embodiments a tip cover is provided. The tip cover includes a first housing portion having a first inner wall curved to form a first cavity, the first housing portion having a first channel recessed into the first inner wall. The tip cover also includes a second housing portion having a second inner wall curved to form a second cavity, the second housing portion having a second channel recessed into the second inner wall. The first housing portion and the second housing portion are configured to be mated together such that (1) the first and second cavities together form a chamber to enclose or surround a nozzle tip, and (2) the first and second channels together form an O-ring channel for receiving and sealing around an O-ring disposed around the nozzle tip. The seal may be an airtight seal resulting in one example from the sealing of the O-ring disposed around the nozzle tip along with a petroleum jelly. Petroleum jelly (also called petrolatum) is a mixture of mineral oils and waxes, which form a semisolid jelly-like substance. Other substants or lubricants could be used as well. Further, as is known in the art an O-ring is a type of gasket.

In example embodiments, the first and second cavities are equal in size and dimension. The chamber formed by the first and second cavities is slightly larger than the nozzle tip and is shaped to receive the nozzle tip. The O-ring of the nozzle tip can fit snugly in the O-ring channel being surrounded by petroleum jelly. The tip cover closes around the nozzle tip of the sealant-dispensing robot and can fit snugly over the O-ring. The first and second housing portions may be mated together in a hinged fashion. A locking mechanism may lock the first and second housing portions in a closed configuration around the nozzle. The locking mechanism may comprise a hook and a loop in which the hook latches to the loop to thereby removably secure the first and second housing portions in the closed configuration around the nozzle. The first and second housing portions when unmated can open outward to expose the first and second cavities, thereby allowing an operator to easily clean the inside of the tip cover or add more petroleum jelly as needed.

In another aspect, a method of sealing a nozzle tip of a sealant-dispensing robot is provided. The method includes providing a first housing portion having a first inner wall curved to form a first cavity, the first housing portion having a first channel recessed into the first inner wall. The method also includes providing a second housing portion having a second inner wall curved to form a second cavity, the second housing portion having a second channel recessed into the second inner wall. The method further includes mating the first housing portion and the second housing portion together such that (1) the first and second cavities together form a chamber to enclose a nozzle tip, and (2) the first and second channels together form an O-ring channel for receiving and sealing around an O-ring disposed around the nozzle tip. The method also includes sealing an O-ring of the nozzle tip against the O-ring channel using a petroleum jelly, to enclose the nozzle tip inside the tip cover.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any embodiments described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A and 1B illustrate respective first and second housing portions of a tip cover for covering a nozzle tip of a sealant-dispensing robot according to an example embodiment.

FIG. 2 illustrates a tip cover in an open configuration for covering a nozzle tip of a sealant-dispensing robot according to another example embodiment.

FIG. 3 illustrates a tip cover in a closed and locked configuration for covering a nozzle tip of a sealant-dispensing robot according to an example embodiment.

The figures are not exhaustive and do not limit the present disclosure to the precise form disclosed.

### DETAILED DESCRIPTION

Embodiments of the systems and methods disclosed herein are directed to devices and methods for covering the tips of nozzles of sealant-dispensing robots, urethane being one type of sealant.

Good sealing is required in applications, such as automotive and other sealing applications that rely on, e.g., liquid/air-tight compartments, components, connections, and the like. Achieving a good seal in such good-seal applications depends on consistent dispensing of sealants such as urethane. Many of these applications require consistent bead or line widths dispensed within tight tolerances. Defects of any kind can result in costly scrap or rework.

Robots include sealant-dispensing nozzle tips that can be used to apply the beads. These tips can become clogged or blocked if the sealant cures inside them. Currently, rubber bands and rubber gloves are used to purge the sealant and cover the nozzle tips. However, typical techniques often result in the sealant drying or hardening inside the nozzle tips. This in turn causes an operator to have to clean the nozzle tips by scraping dried sealant out of the nozzle, which can often lead to damage to the tips and result in poor consistency sealant beads being applied to the windshields.

The tip cover of the disclosed technology can prevent the sealant from drying inside the nozzle tips and can thereby allow the nozzle tips to be wiped clean of petroleum jelly (such as with a cloth or by other suitable means) and then purged without causing an operator to have to clean the inside of the nozzle tips.

The present disclosure according to an example embodiment is directed to a tip cover for a nozzle of a sealant-dispensing robot such as a urethane robot. The tip cover comprises two corresponding housing portions (which may be equal halves) that are each curved to form a cavity. The two cavities when brought together form a chamber that is sized and configured to receive a nozzle or nozzle tip and surround or completely enclose the nozzle tip. The chamber is slightly larger in dimension than the nozzle tip so that the nozzle tip can be snugly received in the chamber and be covered with petroleum jelly. Other substances or lubricants that produce similar effects or have similar uses/applications could be used as well. The chamber also includes one or more O-ring channels, located in one example towards the top of the chamber, that seal around a corresponding O-ring at or near a top of the nozzle tip in order to provide an airtight seal completely around the nozzle tip. The combination of the O-ring and the petroleum jelly on the nozzle tip received in the corresponding O-ring channel of the chamber of the tip cover can create an airtight seal, which can thereby prevent the urethane from drying for long periods of time.

In an example embodiment, the two housing portions may be connected or fastened to each other with a fastening mechanism such as one or more hinges. A locking mechanism such as a hook and latch or another type of locking mechanism may be used to lock or removably secure the two housing portions in a closed configuration around the nozzle or nozzle tip. It is of course to be understood that many different types of fastening mechanisms or locking mechanisms, whether currently known or later discovered, are suitable for the present disclosure.

By virtue of the features of the disclosed technology, the tip cover of the disclosed technology can prevent sealant from drying inside the nozzle tip. The tip cover can provide improved consistency in the dispensing of sealants from nozzle tips. Use of the tip covers can enable dispensing of sealant in consistent bead or line widths within tight tolerances, to reduce or eliminate defects that can become costly scrap or rework.

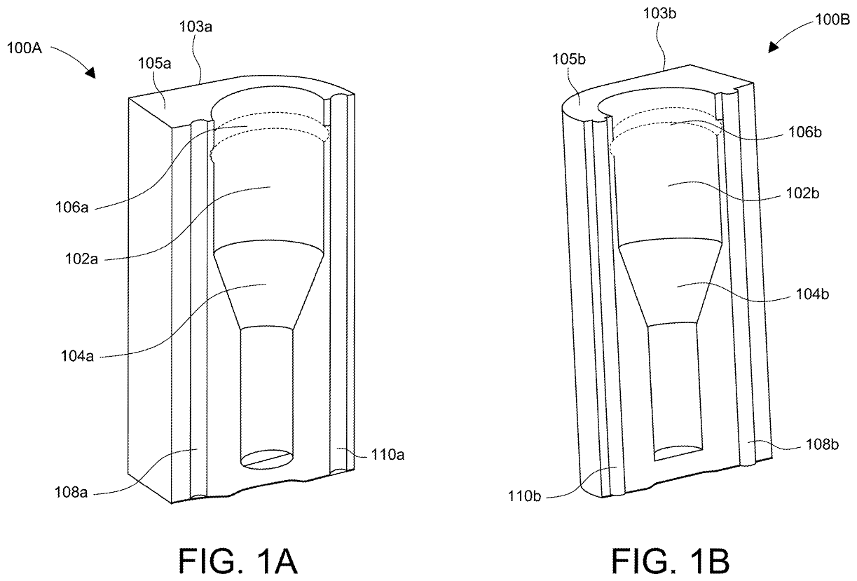

FIGS. 1-3 illustrate an apparatus or tip cover 100 for covering a nozzle tip 200 of a sealant-dispensing robot according to an example embodiment. FIG. 1A illustrates a first housing portion 100A of tip cover 100 and FIG. 1B illustrates a second housing portion 100B of tip cover 100. The tip cover 100 includes a first housing portion 100A having a first inner wall 102a that is curved and shaped to form a first cavity 104a. The first housing portion 100A has a first channel 106a recessed into the first inner wall 102a. The tip cover 100 also includes a second housing portion 100B having a second inner wall 102b that is curved and shaped to form a second cavity 104b. The second housing portion 100B has a second channel 106b recessed into the second inner wall 102b. The first and second channels 106a, 106b may be formed in any suitable location on the respective first and second inner walls 102a, 102b.

The first housing portion 100A has a first outer wall 103a with a first body 105a between the first inner wall 102a and the first outer wall 103a. The second housing portion 100B has a second outer wall 103b with a second body 105b between the second inner wall 102b and the second outer wall 103b.

The first housing portion 100A and the second housing portion 100B correspond to each other in that they are configured to be mated together such that the first and second cavities 104a, 104b together form a chamber to enclose or surround a nozzle tip 200. Also when the first and second housing portions 100A, 100B are mated together, the first and second channels 106a, 106b together form an O-ring channel for receiving and sealing around an O-ring or gasket 202 disposed around the nozzle tip 200. Of course, the present disclosure is not limited to forming only one O-ring channel, and a nozzle tip according to the present disclosure could indeed form one or more O-ring channels, each O-ring channel being comprised of corresponding channel portions on the first and second housing portions 100A, 100B. The seal may be an airtight seal resulting in one example from the sealing in the O-ring channel of the O-ring 202 disposed around the nozzle tip 200 along with a petroleum jelly or similar substance/lubricant.

In example embodiments, the first and second cavities 104a, 104b are approximately equal in size and dimension. This means that the contours of the first and second cavities approximately mirror each other. Of course, the present disclosure is not limited to first and second cavities 104a, 104b that are equal in size and dimension. The chamber formed by bringing the first and second cavities 104a, 104b together when the first and second housing portions 100A, 100B are mated is slightly larger than the nozzle tip 200 and is shaped and configured to receive the nozzle tip 200. In example embodiments the chamber is designed to be slightly larger than the actual nozzle tip that is in use for the sealant-dispensing robot, meaning that the chamber can be coated or filled with petroleum jelly, and the nozzle tip 200 can then be loaded therein, which can create an airtight seal around the nozzle tip 200 to prevent the sealant from drying. The O-ring 202 of the nozzle tip 200 can fit snugly in the O-ring channel formed by the first and second channels 106a, 106b with being surrounded by petroleum jelly. The tip cover 100 can close around or surround the nozzle tip 200 of the sealant-dispensing robot and can fit snugly over the O-ring 202.

In the example embodiment shown in FIGS. 1A and 1B the second housing portion 100B has protrusions or ridges 108b, 110b extending from the body 105b that can be received by respective grooves 108a, 110a formed in the body 105a of the first housing portion 100A when the first and second housing portions 100A, 100B are mated together.

As used in the present disclosure, the terms “mate,” “mated,” mated together” or similar mean that the first and second housing portions 100A. 100B are brought together to form a secure connection that can hold during a process of enclosing the nozzle tip inside the tip cover but is not permanent. In one non-limiting example, the first and second housing portions 100A, 100B may be mated together in a hinged fashion, using one or more hinges 204 fastened between the first and second housing portions 100A, 100B, the hinges providing one mechanism for mating the first and second housing portions together. Another mechanism for mating the first and second houses together are the grooves 108a, 110a on the first housing portion 100A corresponding to the protrusions 108b, 110b on the second housing portion 100B, in which the grooves 108a, 110a on the first housing portion 100A may receive the protrusions 108b, 110b on the second housing portion 100B such that the first and second housing portions 100A, 100B are snapped together or tightly held together, in a secure but not permanent fashion. The above-described mating mechanisms can be used separately or together, and the present disclosure is not limited to the above-described mating mechanisms.

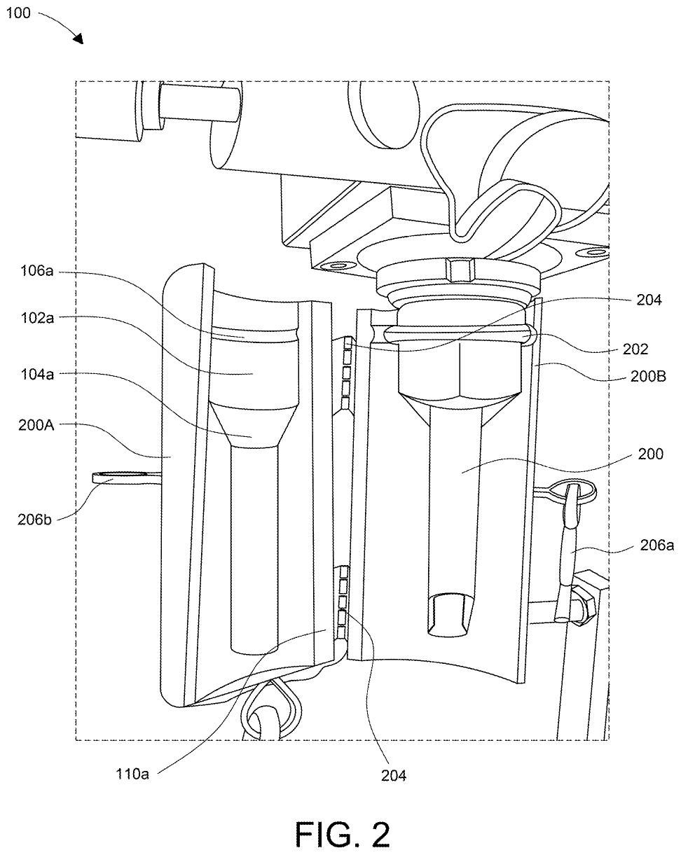

A locking mechanism may lock the first and second housings 100A, 100B in a closed configuration around the nozzle. The locking mechanism in one example may comprise a hook 206a and a loop 206b in which the hook 206a latches to the loop 206b, thereby securing the first and second housings 100A, 100B in the closed or shut configuration around the nozzle tip 200. FIG. 2 shows another example embodiment having a cavity or inner housing that is similar to that of FIGS. 1A and 1B (even though the outer housing or body of the example embodiment shown in FIG. 2 may be different). As shown in FIG. 2, the first and second housing portions 200A, 200B when unmated can open outward to expose the first and second cavities 104a, 104b, thereby allowing an operator to easily clean the inside of the tip cover 100 or add more petroleum jelly as needed. It is of course to be understood that the present disclosure is not limited to the above defined structure or specific components, and that fastening mechanisms other than hinges, or locking mechanisms other than loops/latches, can be used as well.

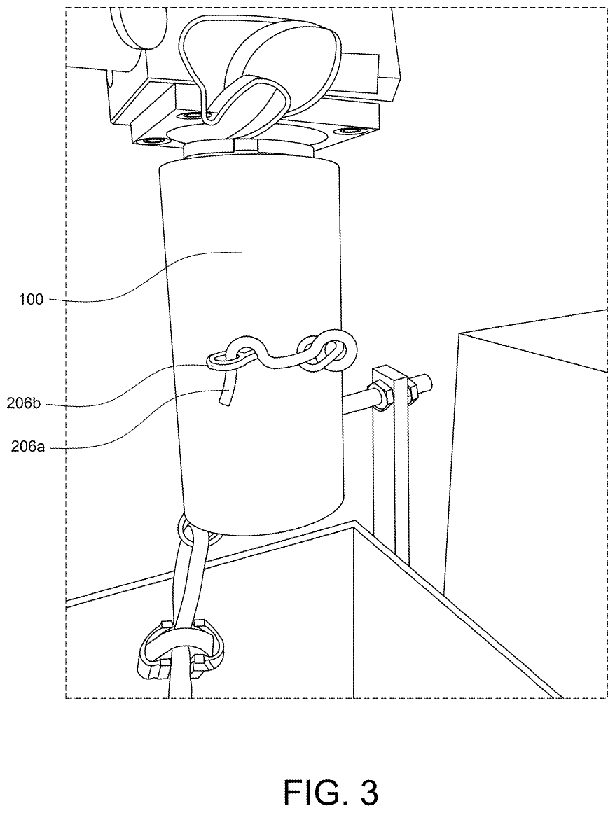

FIG. 3 illustrates a tip cover 100 in a closed configuration for covering a nozzle tip of a sealant-dispensing robot according to an example embodiment. The tip cover is in a closed configuration, the first housing portion 100A being mated to the second housing portion 100B. The tip cover 100 is locked with a locking mechanism comprising a hook 206a and loop 206b.

As used in the present disclosure, an “airtight seal” is a seal that ideally is air tight or near air tight; however it is recognized that a perfect air tight seal may not always be achievable and therefore an “airtight seal” as used herein can refer to a seal that is as good or effective as possible or practical under the given circumstances.

In example embodiments the structure of the tip cover is made of plastic. One way of manufacturing the tip cover is by additive manufacturing, i.e., printing from a 3D printer. Of course, other ways of manufacturing the tip cover are readily apparent. In example embodiments the size and weight of the tip cover is such that the tip cover can be held in or by a person's hand. In any event the size of a nozzle tip cover disclosed herein can correspond to various nozzle tip sizes. It is noted that nozzle tips of sealant-dispensing robots or urethane robots can come in various forms, shapes, sizes, and configurations, and therefore it is of course to be understood that the tip cover of example embodiments of the present disclosure can be adapted to correspond to various forms, shapes, sizes, and configurations of nozzle tips. Moreover, various sealants or urethanes may be used by nozzle tips of sealant-dispensing or urethane robots including but not limited to polyurethane, and the tip cover of example embodiments of the present disclosure can be used with such sealants or urethanes.

By virtue of the features of the present disclosure, the disclosed technology can prevent a nozzle tip from becoming clogged or blocked as a result of sealant curing or drying inside the tip. Thus dried sealant would not have to be scraped out of the nozzle tip in order to clean the nozzle tip, and therefore the cleaning process of the nozzle tip can be made easier. Moreover, such scraping often results in damage to the tip and can thereby lead to the need for earlier replacement of the tips. Accordingly, the disclosed technology can reduce damage to the tips and thus reduce maintenance and replacement costs for the tips. Moreover, consistency of sealant beads or application to windshields or to other apparatuses can be improved.

The tip cover of example embodiments is designed to be slightly larger than the actual tip for the sealant-dispensing robots so that the O-ring channel of the tip cover can be filled with petroleum jelly, which can create an airtight seal around the tip. This can prevent the sealant from drying. The cover can fit snugly over an 0-ring that in an example is applied around a nut that holds the nozzle tip to the robot. This can also create an airtight seal. In one trial the tip cover was left on for 9 days during July shutdown and the urethane was still wet when the tip cover was removed. The tip cover may be attached to the outside of the robot cage with a cable and cable clamps so that the tip cover is not lost.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component can be combined in a single package or separately maintained and can further be distributed in multiple groupings or packages or across multiple locations.

As used herein, “approximately” refers to manufacturing tolerances of permissible variations in physical properties of the embodiments disclosed herein. Dimensions, orientations, and/or configurations disclosed herein may have some acceptable variation within manufacturing tolerances without significantly affecting functioning of the disclosed embodiments.

Additionally, the various embodiments set forth herein are described in terms of exemplary illustrations. As will become apparent to one of ordinary skill in the art after reading this document, the illustrated embodiments and their various alternatives can be implemented without confinement to the illustrated examples. For example, diagrams and their accompanying description should not be construed as mandating a particular architecture or configuration.

What is claimed is:

1. A tip cover, comprising:
a first housing portion having a first inner wall curved to form a first cavity, the first housing portion having a first channel recessed into the first inner wall; and
a second housing portion having a second inner wall curved to form a second cavity, the second housing portion having a second channel recessed into the second inner wall,
wherein the first housing portion and the second housing portion are configured to be mated together such that (1) the first and second cavities together form a chamber to enclose a nozzle tip, and (2) the first and second channels together form a gasket channel for receiving and sealing around a gasket disposed around the nozzle tip.

2. The tip cover of claim 1, further comprising means for mating the first and second housing portions together.

3. The tip cover of claim 1, wherein the chamber formed by the first and second cavities is slightly larger than the nozzle tip.

4. The tip cover of claim 1, wherein the first housing portion has a groove adjacent the first cavity and the second housing portion has a protrusion adjacent the second cavity, such that the groove on the first housing receives the protrusion on the second housing portion when the first and second housing portions are mated together.

5. The tip cover of claim 1, wherein the first and second cavities are equal in size and dimension.

6. The tip cover of claim 1, further comprising a locking mechanism configured to removably secure the first and second housing portions in a closed configuration around the nozzle when the first and second housing portions are mated together.

7. The tip cover of claim 6, wherein the locking mechanism comprises a hook secured to one of the first and second housing portions that latches to a loop secured to the other of the first and second housing portions.

8. The tip cover of claim 1, wherein the first and second housing portions, when unmated, are configured to open to expose the first and second cavities.

9. The tip cover of claim 1, wherein the first and second housing portions are comprised of plastic.

10. The tip cover of claim 1, wherein the gasket channel formed by the first and second channels is configured to receive petroleum jelly.

11. A system for applying a sealant, comprising a nozzle tip and the tip cover of claim 1.

12. A sealant-dispensing robot, comprising a nozzle tip and the tip cover of claim 1.

13. A nozzle tip for a sealant-dispensing robot having the tip cover of claim 1.

14. A method of sealing a nozzle tip of a sealant-dispensing robot, comprising:
providing a first housing portion having a first inner wall curved to form a first cavity, the first housing portion having a first channel recessed into the first inner wall;
providing a second housing portion having a second inner wall curved to form a second cavity, the second housing portion having a second channel recessed into the second inner wall;
mating the first housing portion and the second housing portion together such that (1) the first and second cavities together form a chamber to enclose a nozzle tip, and (2) the first and second channels together form a gasket channel for receiving and sealing around a gasket disposed around the nozzle tip; and
sealing a gasket of the nozzle tip against the gasket channel using a petroleum jelly, to enclose the nozzle tip inside the tip cover.

15. The method of claim 14, further comprising removably securing the first and second housing portions to each other in a closed configuration around the nozzle using a locking mechanism.

16. The method of claim 15, wherein the locking mechanism comprises a hook secured to one of the first and second housing portions that latches to a loop secured to the other of the first and second housing portions.
